(19) United States
(12) Patent Application Publication
(10) Pub. No.: US 2024/0192009 A1
(43) Pub. Date: Jun. 13, 2024

(54) DRONE-BASED OFFROAD VEHICLE ROUTING

(71) Applicant: GM GLOBAL TECHNOLOGY OPERATIONS LLC, Detroit, MI (US)

(72) Inventors: William C. Araujo, Claremont, CA (US); Russell A. Patenaude, Macomb Township, MI (US); Luke J. Popiel, Oxford, MI (US)

(73) Assignee: GM GLOBAL TECHNOLOGY OPERATIONS LLC, Detroit, MI (US)

(21) Appl. No.: 18/080,110

(22) Filed: Dec. 13, 2022

(51) Int. Cl. G01C 21/36; B64C 39/02; G01C 21/34; H04W 4/40

(52) U.S. Cl. CPC G01C 21/3602; B64C 39/024; G01C 21/3461; G01C 21/3469; G01C 21/3617; G01C 21/3647; G01C 21/3694; H04W 4/40; B64U 2101/20

(57) ABSTRACT

Drone-based offroad vehicle routing systems and corresponding methods are proposed. In one aspect, a vehicle and uniquely assigned an aerial drone embedded with sensors, radar, lidar, etc. may establish a data link. The driver or occupant may input information into the user interface in the vehicle about a region or destination of interest. The vehicle's processor may instruct the drone to scout a target region and receive data about the topographic features of the terrain. The drone may scout the region, receive the data, and forward the data to the vehicle. The processor may compute optimal routes based on data from both the drone and the vehicle sensors. In some aspects, the drone performs calculations of the route and may communicate in or near real time with the vehicle. The system may take into account vehicle data, the skill level of the driver, or both.

### INTRODUCTION

The increased sophistication of technologies governing modern vehicles, including but not limited to offroad vehicles, has created a continued progression by consumers to acquire and use such vehicles in more challenging and diverse offroad terrains. With these activities, the need for more precise and responsive navigation systems has become an important overall factor. To facilitate such experiences by these consumers, manufacturers have turned their attention to providing more robust routing systems with increased overall capabilities that extend beyond mere well-established transportation infrastructures and that incorporate newer and more useful features.

### SUMMARY

The present disclosure expands the precision and robustness of modern navigational systems in an offroad context by integrating information obtained by an aerial drone (“drone”) scouting a target region with vehicle information and in some embodiments, driver skill and historical driver ability. Information from the drone may be used to evaluate a plurality of natural and artificial offroad conditions including terrain types, incline levels, obstacles and the like. Aspects of the present disclosure including assigning the drone by the vehicle to gather terrain-based information and to use that information by the vehicle in conjunction with vehicle-specific criteria from its own sensors, including vehicle parameters, driver capabilities, driver skillset, driver profile, etc., in integrated predictive analyses in which optimal routes may be considered using information from a combination of the drone and the vehicle.

### In an Aspect of the Present Disclosure

In another aspect of the disclosure,

The above summary is not intended to represent every embodiment or every aspect of the present disclosure. Rather, the foregoing summary merely provides an exemplification of some of the novel concepts and features set forth herein. The above features and advantages, and other features and attendant advantages of this disclosure, will be readily apparent from the following detailed description of illustrated examples and representative modes for carrying out the present disclosure when taken in connection with the accompanying drawings and the appended claims. Moreover, this disclosure expressly includes the various combinations and sub-combinations of the elements and features presented above and below.

### BRIEF DESCRIPTION OF THE DRAWINGS

The accompanying drawings, which are incorporated into and constitute a part of this specification, illustrate implementations of the disclosure and together with the description, explain the principles of the disclosure.

FIG. 1 is a conceptual diagram of a system including a vehicle in an offroad area using drone technology to aerially scout a target region.

FIG. 2 is a flow diagram illustrating an example integrated process for drone-based offroad vehicle navigation.

FIG. 3 is a flow diagram illustrating example criteria taken into account by the drone or the vehicle in using artificial intelligence to identify optimal routes.

The appended drawings are not necessarily to scale and may present a simplified representation of various features of the present disclosure as disclosed herein, including, for example, specific dimensions, orientations, locations, shapes and scale. Details associated with such features will be determined in part by the particular intended application and use environment.

### DETAILED DESCRIPTION

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including,” “containing,” “comprising,” “having,” and the like shall mean “including without limitation.” For example, “optimal vehicle routes” may include one or more optimal vehicle routes. Moreover, words of approximation such as “about,” “almost,” “substantially,” “generally,” “approximately,” etc., may be used herein in the sense of “at, near, or nearly at,” or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

The principles of the present disclosure are directed to systems and methods for drone-based off-road vehicle routing to create a more dynamic and robust offroad vehicle navigation experience. In the aspects to follow, an aerial drone may be associated as a client or slave in a client-server or master-slave system with a vehicle. The drone may have a unique numerical or alphanumeric character string assigned to it that qualifies as an identifier uniquely used by the vehicle for controlling the drone as a client. In this example, the vehicle acts as a server. Configurations of the disclosure leverage the benefits of sensors implemented in aerial drones. These sensors include, but are not limited to, sonar devices, radar systems, lidar systems, thermal devices/thermometers/temperature measurement devices, night vision equipment, and other sensors equipped with the drone and capable of being engaged, selectively or continuously, to receive input data while the drone is in the process of scouting a target region in response to instructions from the vehicle.

In various aspects, input data collected by these and other sensors from the drone may be transmitted back to the vehicle, in or near real time while the drone is in flight, or after the drone has return and docked with the vehicle using a plurality of possible docking configurations. As the server device with a central navigation system, the vehicle includes a processor that may evaluate the input data from the drone sensors. The input data from the drone sensors may be supplemented with other input data from one or more vehicle sensors, predictive navigation algorithms programmed in the vehicle, and driver behavior data received from vehicle sensors or input into a user interface of the vehicle to enable the processor within the vehicle to not just assess terrain more precisely and accurately, but also to provide valuable guidance criteria for a driver. For example, in various aspects, the processor in the vehicle is configured to combine the input data received from the drone sensors with the input data received from the vehicle sensors, to select the most relevant data from both sources (e.g., input data from at least one or some of the drone sensors together with input data from at least one or some of the vehicle sensors) to ultimately determine optimal vehicle routes for enabling the driver to negotiate the upcoming terrain using the desired route. The processor may also use the global positioning system (GPS) navigation features along with other preexisting features germane to the target region to determine optimal routes.

Accordingly, at the outset, the processor of the vehicle may integrate real-time input data from the vehicle and drone sensors with vehicle data and driver capabilities and preferences to provide a customized navigation solution or set of solutions from which the driver may select. Driver capabilities may include skill levels ascertained by the driver, for example, from successfully completing prior courses as determined by vehicle (and in some cases, drone) sensors and other vehicle hardware, as well as specific obstacles historically overcome successfully or unsuccessfully by the driver, again as determined by driver sensors and algorithms executed on the processor.

In other aspects, the drone-based routing enables integration of a plethora of input data types from the various sensors equipped on the drone that represent characteristics and topographic features relevant to possible offroad vehicle routes with vehicle data analyzed by the processor therein.

The principles of the disclosure find particular utility in regions where the levels of detail regarding topographic conditions is not widely understood, or changes over time. Examples of topographic features for the purposes of this disclosure include new or previously unknown routes where the desired level of detail may be dynamically created by the drone-based vehicle routing system. These types of regions often include new dimensions like natural obstacles (trees, rocks, rivers, obstacles in general elevation, and the like). Thus, the system may be widely advantageous for use in more natural environments that are typically not contemplated in today's crowd sourcing or navigation databases.

Nevertheless, it is often the case that such natural or less familiar regions are closely adjacent—and sometimes within—much more populous regions that include roads, structures, and other element of modern civilization. Therefore, it should be understood for purposes of this disclosure that topographic features is intended to specifically include and encompass both natural and artificial features of a terrain in whatever form. For example, for purposes of this disclosure, topographic features includes not only anticipated routes but pre-existing routes and pathways, including without limitation roads, paths, or other routes (e.g., as defined by a full width road or mere parallel tire tracks), whether paved, dirt, gravel or otherwise. Thus, while a target region for prospective navigation by a vehicle (or occupants thereof) may be an offroad region, the region may nevertheless include, in various circumstances, freeways, buildings, skyscrapers, and a range of other architectural structures. The various features of each of these structures and objects are included within the concept of topographic features. Thus, the topographic features that may be received as input data by the drone (or vehicle) sensors include the arrangement of the natural and artificial physical features of an area, and physical measurements and phenomena that may be relevant to these features. As one example, relevant topographic features received by a drone from its sensor set may include, without limitation, data relevant to terrain; vegetation canopies; inclination at different regions; approach or departure angles; slope angle; natural or artificial obstacles; temperature; pavement types; rivers, lakes or bodies of water or conditions thereof, presence or location of social media members (in an off-roading club, for example); distances; path widths; road widths, and geographical or geometrical measurements of whatever nature. In various configurations, the vehicle is further equipped with sensors so that input data may be received and analyzed by the vehicle's processor along with the data received from the drone. The drone's aerial view accords it an advantage with respect to acquiring or sensing input data from various altitudes above a target region (which may broadly be a predetermined region stored in a memory coupled to the processor, coordinates or equivalent mapping information provided by the driver or other occupant via a user interface, or otherwise).

In further aspects, the processor may be configured to selectively analyze this data. The processor may be configured to selectively assess relevance of the input data from the drone and vehicle sensors, to determine, optimal routes to the destination based on the selective assessment, and to display the optimal routes to a driver via the output display.

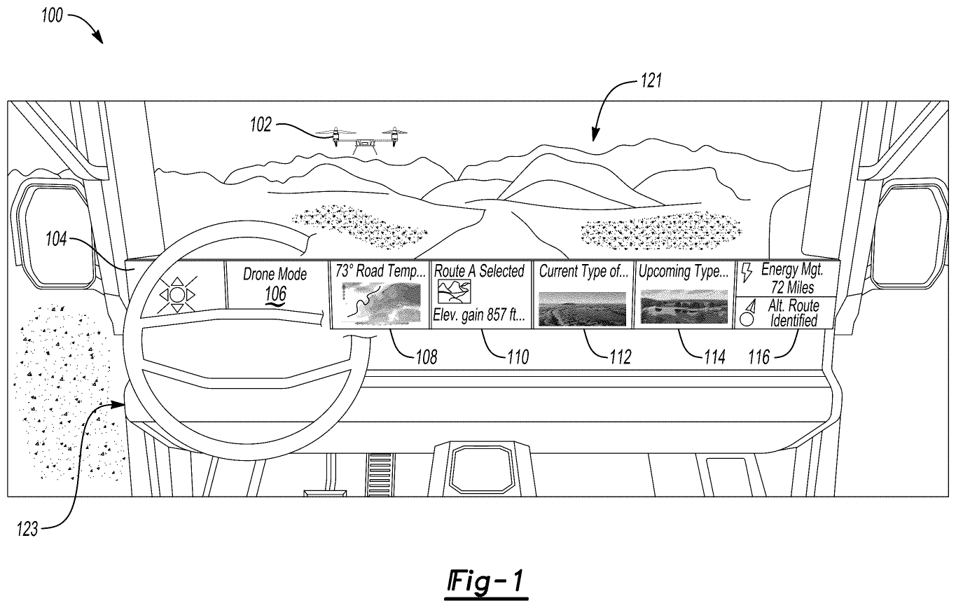

In addition to integrating the information received from the different vehicle and drone sensor sets to acquire optimal routes and display them to drivers and occupants of the vehicle via an output display (e.g., a light-emitting diode (LED) display, a liquid crystal display (LCD), an organic LED display, a quantum dot-based LED display, or the like), which may also constitute a plurality of discrete displays (see, e.g., FIG. 1). In further aspects, in addition to the traditional route information typically provided the vehicle occupants, the integration and predictive, and artificial intelligence capabilities of the drone-based routing system further allows the processor to customize the information displayed, voiced, or otherwise conveyed to the driver. Routing data output to the driver may broadly include additional information beyond the scope of existing routing systems. Illustrative routing data according to different configurations may include range effects (e.g., information identifying, for a plurality of identified optimal routes, the estimated energy consumption and/or mileage information that may be consumed or incurred on each route), skill level required, and the creation of new paths not previously considered.

In related aspects, specific vehicle data obtained from vehicle sensors may include ground clearance, width, turning radii, climbing capability, vehicle range, and others. In these aspects, using specific vehicle data in combination with information obtained from drone assessments (e.g., clearance between natural obstacles, depth of water hazards, and the like) to enable the processor to provide feature-rich and precise determinations. Vehicle sensors may broadly be considered to include electric, mechanical, electromechanical, solar, or other element, component or device types that are configured to receive or store vehicle-specific information. Certain features (e.g., turning radius) may be understood in advance and stored in a memory, but the radius of a turn may be practically affected by the incline of the terrain, the presence of obstacles, and other criteria that may need to be taken into account. Thus, for different routes, different sensor data may be used to evaluate pre-stored information.

In further aspects, vehicle telematics, including sensors and related infrastructures that assess driving performance, driving styles, speed management, handling of turns, reaction times, and many other instances of driver conduct when the vehicle is in motion may be used by the processor to score driver ability. The vehicle may use its combined array of terrestrial and aerial sensors available to assess route complexity in view of the determined ability of a driver. With this information, the requirements for different routes may be determined and conveyed to the driver.

In other aspects, offroad routes may be recommended based on vehicle's capabilities, such as climbing capability, range, speed, maneuvering capabilities, and the like. These recommendations may include combinations of vehicle capabilities and driver capabilities and/or driver skill level. The processor may be configured to make overall recommendations based on these and other criteria.

Further, while aspects of the disclosure are directed to offroad vehicular navigation in an offroad area or an offroad target region, the use of the terminology “offroad” does not exclude the presence of roads, buildings, and other artificial structures within the offroad area or offroad region. For example, a present location of a vehicle may be a paved road. An offroad area or region qualifies as offroad for purposes of this disclosure where a part or each of at least one of the possible routes from a present location to a destination is offroad for even a short distance.

The vehicle may engage the drone using a suitable communication technique to create a data link for the mutual exchange of data and instructions between the vehicle and drone. The data link may use Bluetooth™, available cellular and mobile broadband networks, 3G, 4G, and 5G networks, point to point wireless networks, and a host of other proprietary or publicly familiar communication protocols may be used to set up a communication link. In this disclosure, the terms “wireless link,” “communication link,” “data link,” and related terms as clear from the context refers to a way for the drone and vehicle to communicate wirelessly. These terms are broadly intended to encompass configurations in which the drone transmits information to the vehicle and/or the vehicle transmits information to the drone. For example, a link may broadly encompass a plurality of transmissions from either device over a period of time, a single instruction, or anything in between. The data link need not be a duplex link. In various configurations, the vehicle's powerful processing capability may make it a better candidate to be a master or server in a master-slave or client-server relationship. For purposes of this disclosure, either entity—the drone or the vehicle—may establish the data link or similar network connection.

In still other aspects, the data may additionally or alternatively be transferred from the drone to the vehicle after the drone has returned from an aerial scout mission. These configurations may be helpful where the vehicle happens to be stationary, or the drone has a need to charge or otherwise be fueled. In this latter case, the drone may transfer data to the vehicle using a wired link at a preconfigured docking station. The docking station may be positioned on the vehicle, or in some configurations it may be taken from inside the vehicle with power or data cables coupled when suitable from the drone to the vehicle.

In other cases, the dynamic nature of the routing solution herein may benefit most where the drone selective engages its sensors while performing an aerial scout, or coordinated data-gathering flight, of a target region. While performing the scout, in some aspects, the drone selectively transmits highly relevant information to the vehicle in advance or near real time, for example. Alternatively, or in addition, the drone may engage specific sensors at the request of the vehicle and/or transmit requested data back to the vehicle. The processor in the vehicle may be used to vary the flight parameter in real time to obtain data. In this latter example, the processor may also be used to control the flight itself. That is, in some aspects, the vehicle controls at least a portion of the flight, using its suite of algorithms to steer the drone to different altitudes, longitudes, and/or latitudes as deemed ideal by the processor. In other aspects, particularly with respect to new scouting missions of largely unmapped terrain (that is, terrain not previously analyzed by this vehicle or another vehicle in the case of a network of cooperating, self-learning vehicles sharing information), the drone may control the flight. Ultimately, the amount of control accorded the drone during its scout may depend on numerous factors, including preexisting knowledge by the vehicle of the target region (if it exists), the sophistication of the controller within the drone and the general capabilities of the drone, and the outcome of predictive algorithms.

In short, as noted above, in one aspect of the disclosure, the offroad solution enables the vehicle-drone combination to collect data using sensors from both the drone and the vehicle, and to detect and characterize optimal vehicle paths for display on an output display device in the vehicle. In other aspects of the disclosure, the drone-based vehicle-routing system may further be used for energy management. In the example case of an electric vehicle (EV), the driver may be off-roading and may elect to make better decisions relative to the vehicle's estimated range while remaining after facing obstacles, inclinations, distances, and other potentially other factors associated with taking one of the identified offroad routes. The driver may need assistance in determining whether the EV will be left with a sufficient range to travel back home, or to a charger. The present configurations may use the sensor data to quantify these estimations in a more precise and robust manner. For example, the aerial scouting by the drone may provide the vehicle with much more relevant data relating to the obstacles, inclines, and other hazards that may have a profound effect on energy consumption of the EV, versus more straightforward paths that may currently be obscured from view (e.g., due to mountains or trees in the terrain). In these configurations, the processor need not simply make such estimations of range based on distances and limited information. Rather, the processor may be able to retrieve significant amounts of data characterizing the routes that enables estimated ranges to be determined with far greater precision. These advantages of energy management apply equally in hiking situations and other activities involving the drive and vehicle occupants.

The benefits of the present drone-based system may further be facilitated with vehicle telematics that maintain a record of the driver's driving habits, behaviors, successes and failures over known routes, and other driver skills. With this information, the system may maintain a driver capability rating and may thereby combine the driver's skill level with the calculated or pre-familiar route difficulty. With this combined information, the vehicle may arrive at a route difficulty not merely in the abstract, but one that is particular to a driver. The processor within the vehicle may use self-learning to increase the precision and overall diversity of a driver's profile. For example, as more information about the driver's habits is received from the vehicle sensors (or drone sensors), that information may be cumulatively added to the existing information and the driver skill level may be recalculated based on the newly acquired data.

Yet another benefit of the drone-based system is that the aerial view of the drone places it in a unique position to assess the topographic features of the terrain with a potentially exceptional level of detail. That data may be transmitted back to the vehicle over the existing data link and stored in a repository. The processor may use the combined set to understand not just specific obstacles, but also overall conditions for a particular route of interest to the driver. The effect on vehicle range and the trip viability to the destination and (where applicable) back to the point of return may be assessed with high levels of precision. These benefits may be particularly useful for providing hiking guidance, for example. In one case, the driver may program the system via a user interface to provide hiking guidance. The processor may use collective sensor information to evaluate optimal routes on foot. Without the system, the hikers would be left to the existing knowledge of the terrain, if they have it in their possession. The system may provide criteria for hiking guidance and determine relative pathway difficulties. This may be particularly useful for final legs of a journey that are inaccessible in the vehicle or that are obscured from view.

Accordingly, the suite of algorithms depicted herein, together with the vehicle and drone computational and networking infrastructures

Referring to the drawings, wherein like reference numbers refer to like features throughout the several views, FIG. 1 is a conceptual diagram of a system 100 including a vehicle 123 in an offroad area using a drone 102 to aerially scout a target region 121. The target region 121 may represent an area within the offroad area ahead of the vehicle 123 to which the driver would like to travel. The vehicle 123 may be equipped with a user interface and an output display which in this configuration are collectively characterized by drone controls 104 to enable manual driver control of the drone; drone mode 106 to display representative maps of the region, incorporating GPS or other preexisting mapping systems, and to display menu buttons that enable the driver/occupant to switch between automated versus manual drone control and to input criteria relevant to the target region that the driver would like the drone to aerially scout; output display 108 which shows an estimated view of the road temperature above, as well as an average temperature for the next five miles; 110 which may show that Route “A” has been selected from the list of routes, along with a gain in elevation and a level of difficulty of Route A, and including a touch point for highlighting various obstacles that may be encountered in the upcoming target region 121; wherein output display 112 may show a current type of terrain, such as for the next 4.3 miles along with a photograph of the terrain and a description of the conditions wherein output display 114 may further include a display of upcoming (versus current) terrain of up to 4.4 miles ahead (in this example) that the driver may anticipate, in addition to a symbol of a river or other obstacle and its estimated width and depth; and an energy management screen 116 which estimates the mileage range for which the driver can safely return. The energy management screen may include a description of alternate routes ahead, levels of difficulty, energy management factors and other information. In some variations, the co-pilot user interface including the drone controls 116 may also include a co-pilot control center that acts as an output display for reproducing different aerial and vehicular views of the offroad pathway ahead of the vehicle. The co-pilot in some examples may scroll through different screens and assist the driver in the navigation process. Verbal communication may be used between the two occupants to optimize the off-roading experience. The user interface may also include dedicated buttons or may be part of a touchpad that is also capable of presenting output through its output display capability.

FIG. 1 represents an exemplary, non-exhaustive configuration of a multi-tier output display with dual functionality for enabling inputs. In other configurations, the output display and user interface may be separate or discrete. For example, there may be dedicated buttons or a keypad for inputting information. The output display may be singular and may be scrollable via an adjacent button in other examples. The particular arrangements of the output display(s) and the user interface may vary without departing from the principles of the present disclosure.

The target region 121 may include an offroad region that may be selected by the vehicle occupants. The target region 121 may also be selected by the processor in the vehicle as well as the drone 102 based on input criteria from the driver or other occupants. In some configurations, the driver may specify an area ahead of the vehicle 123, and the processor may proceed to instruct the drone 102 to scout the target region 121 and transmit back sensor data during the flight. The target region 121 in some cases may be dynamic and may change depending on the real time selections of input data by the occupants of the vehicle 123, findings by the drone 102 via the drone sensors, evaluation of drone and vehicle data, and other factors. In other arrangements, the target region 121 may remain static.

Underlying the output display mechanisms and user interfaces detailed in the example of FIG. 1 is the vehicle processor, which performs determinations of optimal route, predictive algorithms, self-learning algorithms, determinations of driver experience and skill based on prior routes and prior failures and successes in negotiating obstacles, and assessments and control of data received from the drone and vehicle sensors as well as data stored in a repository relevant to the target region 121 for detecting and characterizing future routes. It will be appreciated that the term “processor” for purposes of this disclosure may not simply be limited to a single vehicle processor but may encompass different physical circuit configurations. Non-exhaustive examples of the “processor” include (1) a plurality of processors in the vehicle that collectively perform the various navigation and routing-related tasks, and (2) processors of different types, including reduced instruction set computer (RISC)-based processors, complex instruction-set computer (CISC)-based processors. The procedures and instructions may be executed in software, hardware, firmware, middleware, application programming interfaces (APIs), or some combination thereof. The “processor” in this disclosure may, for example, include hardware implementations such as digital signal processors (DSPs), application-specific integrated circuits (ASICs), field programmable gate arrays (FPGAs), discrete combinational logic, etc. In these configurations, the processors may be coupled together via different circuit boards. The “processor” therefore represents the physical components within the vehicle responsible for receiving data from the vehicle sensors and one or more memories within the vehicle and for executing the various programs related to the drone-based vehicle routing system. Further detail describing the vehicle architecture and processor is shown in FIG. 6A.

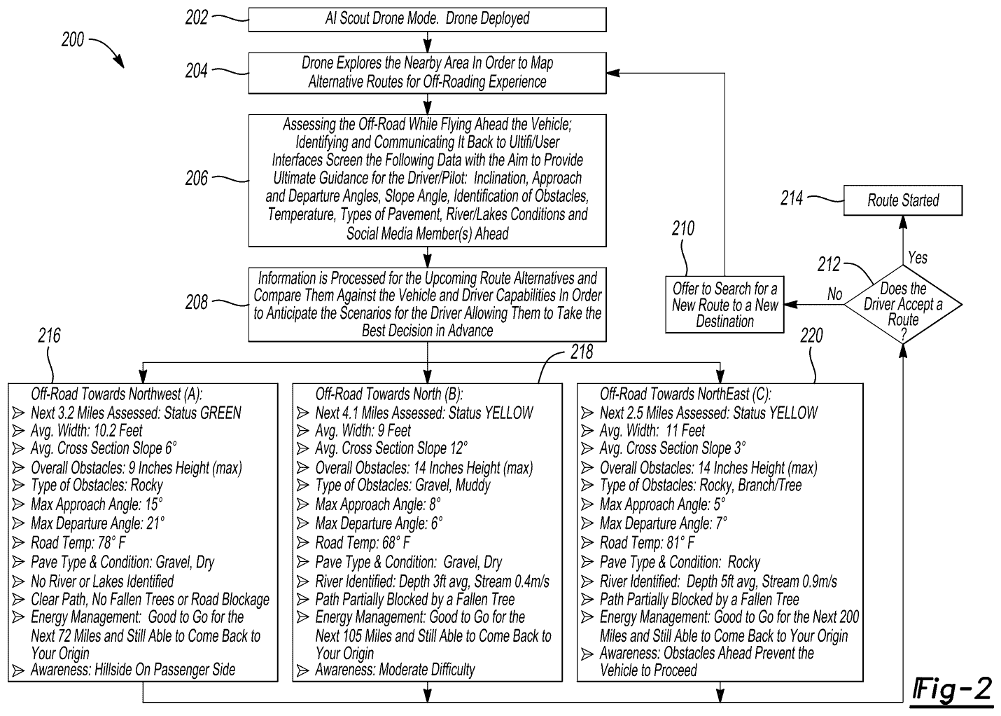

FIG. 2 is a flow diagram 200 illustrating an example integrated process for drone-based offroad vehicle navigation. In some aspects, FIG. 2 describes a suite of artificial-intelligence algorithms uniquely developed for off-roading purposes. The algorithm suite, as noted above, is supported by sensors on the drone 102 and the vehicle 123. The drone sensors may include lidar, radar, sonar. thermo-sensors, night vision sensors, wide angle and telephoto cameras, accelerometers, vibration and seismic sensors, and other equipment that may be incorporated into the drone 102, depending in part on its sophistication, amount of stored flight energy, and maneuvering capabilities.

In one example algorithm in flow diagram 200, the vehicle's navigation/routing system is placed into artificial intelligence (“AI”) Scout Drone Mode. The drone 102 is thereupon deployed at block 202. The drone proceeds to explore the nearby area in order to map alternative routes for the continued or anticipated off-roading experience, as displayed in block 204. In some implementations, the vehicle sends the drone via a data link a predetermined point of interest (POI), or a latitude/longitude position. The POI or position may constitute an anticipated location, from which the processor or drone may further compute the target region. Proceeding to block 206, the drone may assess offroad conditions while flying ahead of the vehicle into the target region (that in some cases is identified by the drone during its initial aerial scouting). The drone proceeds to engage its sensors to thereby receive input data. The drone may capture images, video, and other information relevant to the possible vehicle routes (or anticipated hiking routes in some configurations). The drone may communicate the received input data back to the vehicle for display on the user interfaces (see FIG. 1). One objective of this approach is to provide an ultimate guiding experience for the driver or drone pilot as also described in block 204. Example input data conveyed from the drone 102 to the vehicle over the data link established therebetween includes inclination data, approach and departure angles, slope angles, identification and presence of obstacles, temperatures, types of pavements, presence of rivers, lakes or other bodies of water, and other data including identification of artificial obstacles (cell towers, structures and the like). In some configurations, the driver may belong to one or more social media groups in different platforms that attract off-roading enthusiasts. The drone 102 may also use cellular or other network capabilities to identify members of the relevant social media group that happen to be driving in the target region 121 or in the offroad area ahead of the vehicle. This data may similarly be transmitted back to the vehicle.

At block 208, the vehicle may process this information using information from both the drone sensors (including selected ones thereof) and the vehicles sensors (or selected ones thereof). For example, the processor may run a comparative assessment and reconciliation of artificial intelligence (AI) data captured by the drone exploration in combination with the vehicle's capability, geometry, and diagnostics. Examples of this comparative analysis include where the processor determines that rocks detected by the drone sensors are taller than an undercarriage clearance of the vehicle. Similarly, the processor may identify an obstacle, such as the rocks detected by the drone, and may determine that the vehicle specifications and its capabilities are unable to overcome the obstacle height. As another illustration, the drone may identify trees near the pathway. The processor may determine that the distance between the two trees as conveyed by the drone is too narrow for the vehicle, with its width, to pass.

The information identified by the drone may be compared against the capabilities of the vehicle (stored in a vehicle data bank, repository, or other memory, captured by the vehicle from its sensors, or some combination thereof) as well as the driver capabilities. This comparison may be used in an overall assessment to determine at least one optimal vehicle route. The processor may use this information, for example, to anticipate the scenarios available to the driver and may communicate this information to the driver. As noted in block 208, this resulting information from the processor may allow the driver to make the best decision in advance by taking the best appropriate route in light of the driver's experience, the vehicle's capabilities, and the terrain that lies ahead. As noted, in some aspects, the driver behavioral history compiled into a vehicle database from the sensors over a period of time may be used to create a profile of driver history, such as skill level. Examples may include a range from 1-10, or in other cases, Beginner/Intermediate/Expert.

Referring still to FIG. 2, blocks 216, 218 and 220 illustrate examples of vehicle routes identified by the processor after executing the above-described algorithms and taking into account in the assessment relevant data received from one or more selected drone sensors combined with one or more selected vehicle sensors. Block 216 in this example conveys data about an easy route. Block 218 conveys data about an intermediate route. Block 220 conveys data about an expert or difficult route. The relative ease or difficulty of the routes, and the overall route suggestions, may be determined in some aspects by a numerical value, by a color, by a symbol, etc. In some configurations, the processor may determine the level of difficulty of the route based on vehicle information and based on the drone and vehicle sensor information with or without taking the driver's skill into account. In other configurations as noted, the respective levels of difficulty are relative to the vehicle's capabilities, and the driver's experience, skill level, and/or preferences input by the driver into the user interface. The processor in one configuration just conveys routes that are physically achievable.

At block 216, the vehicle has identified as route A an offroad route towards the Northwest. The data includes an indication that the driving status is GREEN for the next 3.2 miles, which may be the total distance of the route. In other configurations, the data may also be broken up into legs up to a destination. This status may indicate that the route is sufficiently wide, and the inclines are sufficiently manageable such that the overall route for this leg is straightforward. As noted above, the assessment of driving status may be made relative to the skill level of the driver, or it may be made without this information if the latter information is not used or otherwise unavailable. The average width of 10.2 feet conveys the average width of the path over the route (or in other embodiments, a leg of the route). The average cross sectional slope is shown as six degrees. The obstacles identify a maximum height of nine inches. The terrain is deemed to be rocky. Block 216 also identifies maximum approach and departure angles for the driver's approach to the destination and return from the destination. The road temperature is identified as well. The pavement type and condition is reported to be dry gravel. No nearby bodies of water are identified in the easy route of block 216. The path is clear, with no fallen trees or road blockage. The energy management data is also reported, estimating 72 miles of further range while still affording the vehicle enough charge/fuel to successfully return to the origin (which may vary depending, for example, on whether the origin is the present location, or a home). Awareness data is also reported, indicating in block 216 the presence of a hillside on the passenger side of a vehicle.

Blocks 218 and 220 report the same data types in this example, but with different spatial directions, obstacles, inclines, temperatures, and other factors. For example, block 218 reports obstacles that include gravel and muddy areas, with the pavement type more typically dry gravel. Both blocks 218 and 220 report the presence of a river with different average depths. Both paths in blocks 218 and 220 also report a blockage of the path by a fallen tree. Block 220 also reports obstacles that prevent the vehicle to proceed, meaning at a minimum that the vehicle would be required to travel around the obstacles and are incapable of simply traveling over them.

Referring next to decision branch 212, the processor determines whether the driver accepts a route, e.g., by tapping a desired route on a touchscreen display or otherwise selecting the route through a user interface. If so, at block 214, the route is started, and the driver may proceed with the assistance of the navigation system. Otherwise, at block 210, the vehicle may output an offer to search for a new route to a new destination. If the driver accepts the offer, in some aspects the driver may specify the destination or information that allows the processor to estimate the destination. Control may be returned to block 204, as the processor instructs the drone to explore a target region associated with the new destination, and the process of assessment may proceed accordingly. While the system in the example of FIG. 2 output three different routes, in other cases a greater or fewer number of routes may be identified and provided as an option to the driver.

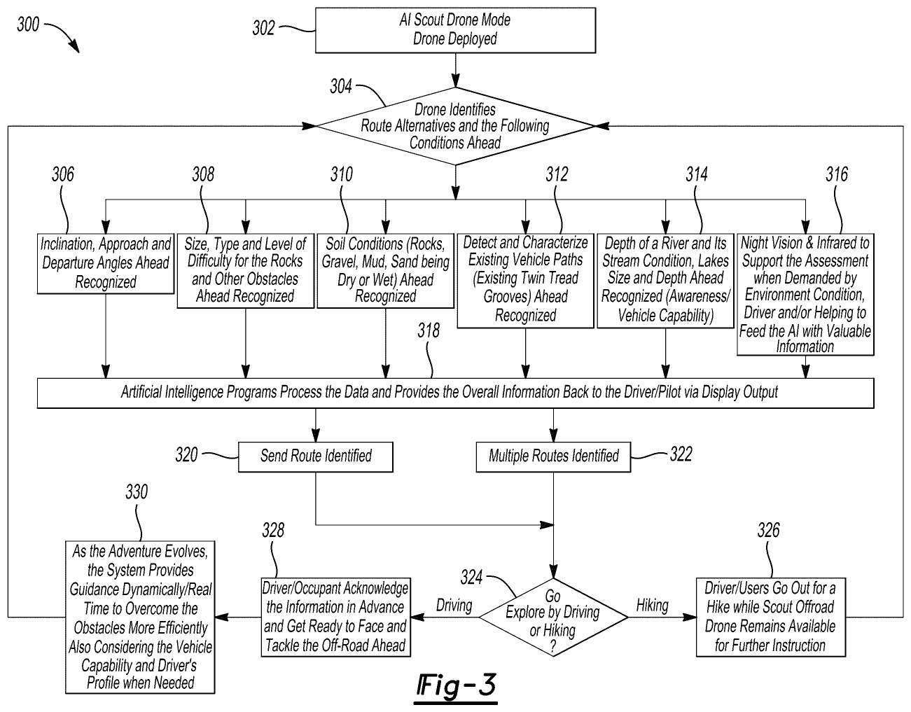

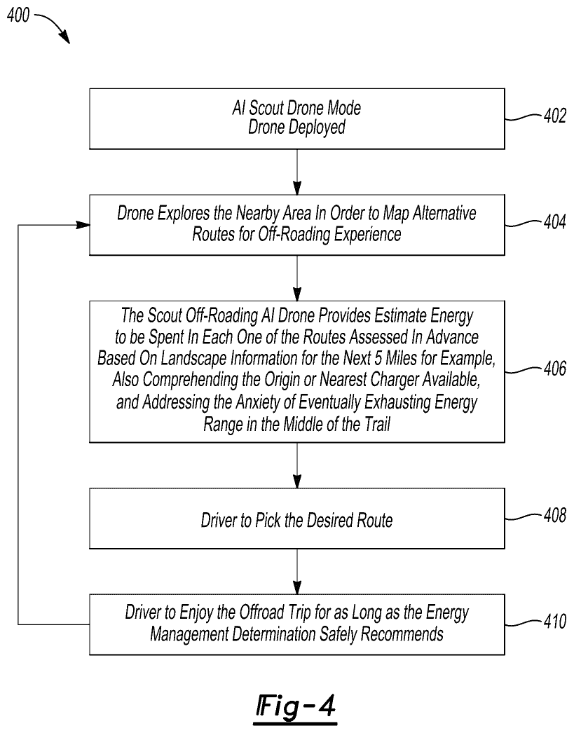

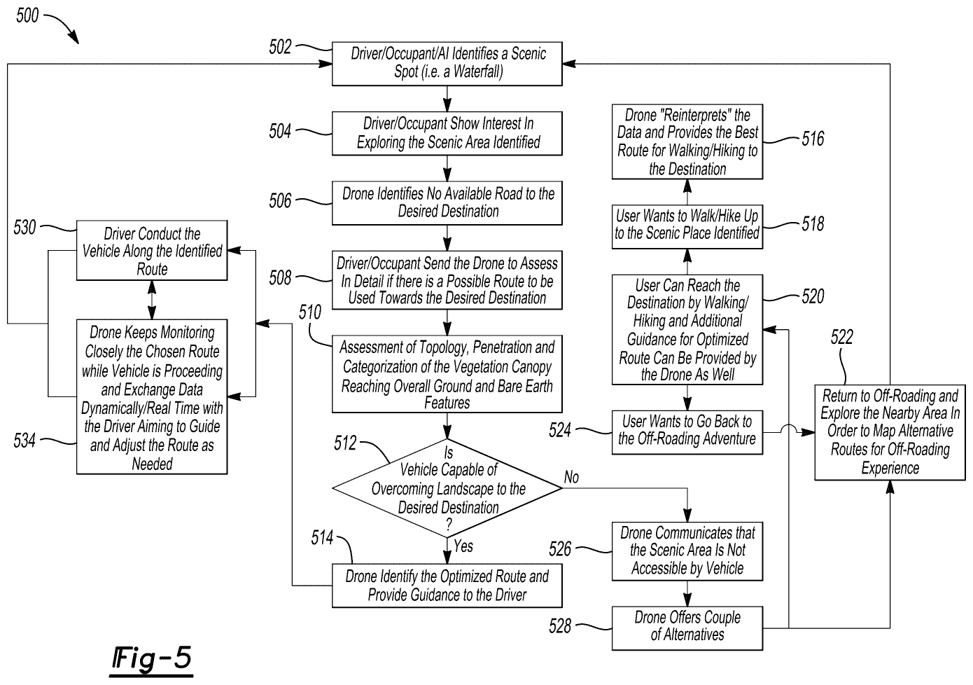

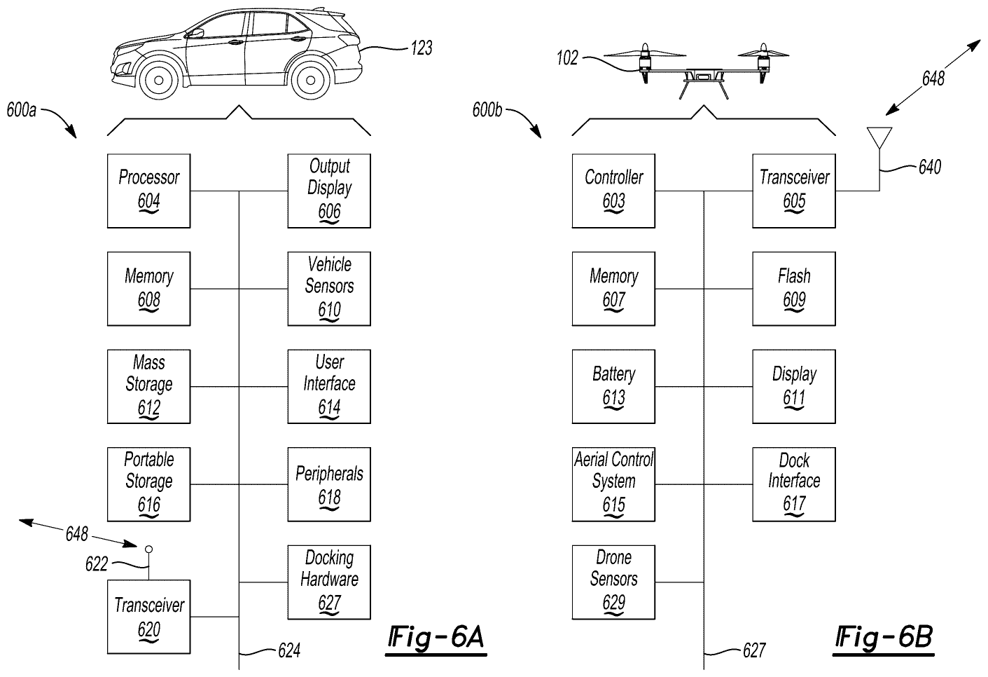

FIG. 3 is a flow diagram 300 illustrating example criteria taken into account by the drone or the vehicle in using artificial intelligence to identify optimal routes. While specific criteria are captured by the scout drone, with the data including the criteria being transmitted over the data link to the vehicle, it will be appreciated by those in the art that other criteria may be considered and used in the processor's determination. As with FIG. 2, the steps in FIG. 3 may be performed by the vehicle (e.g., the processor), the drone (e.g., a controller therein), by some combination of the drone and vehicle sensors, or the like. The processor may use AI data stored in memory in the vehicle as well as the driver's experience and skill level similar to a manner described above.

The driver may initiate the drone-based routing system. Referring to block 302, and upon receiving input through the user interface or based on another trigger, the processor may set the navigation system to AI scout drone mode, in which case the drone may be deployed to initiate the flight(s). At decision block 304, the drone 102 may identify road or route alternatives and a number of conditions ahead. In some implementations, the drone's controller (see FIG. 6B) may perform more sophisticated functions, thereby potentially taking some of the processing load otherwise performed by the vehicle 123. For example, the drone 102 may identify actual road or route alternatives based on its receipt of data from the drone sensors as it aerially scouts the region of interest. At block 306, the controller may retrieve inclination, approach and departure angles ahead of the vehicle in the target region based on an input data from one or more of the drone sensors. Hilly or mountainous regions are likely to have higher inclines.

At block 308, the drone's sensors may recognize and collect data concerning the size of rocks and other obstacles that lay ahead. The controller (drone) or the processor (vehicle) may use this data to determine the effect on the level of difficulty of the route. At block 310, the drone may use a combination of its sensors to determine soil conditions at various locations within the target region. Examples include rocks, gravel, mud, sand (dry or wet), fallen trees, artificial obstacles, etc. The controller on the drone may determine the nature of the object based on data received from different sensors, such as, for example, image recognition algorithms run on photographs or video feed, temperature assessments, detection of water, radar, lidar, seismic-based sensors, sonar, etc. As with the other recognized topographic features, the data corresponding to the soil conditions may be forwarded to the processor so that the vehicle may perform an independent assessment of the data.

At block 312, the drone may recognize, detect and characterize existing vehicle paths. The controller may detect such paths, for example, by recognizing the presence of twin tread grooves that are approximately parallel and that extend along some portion of the region. In some configurations, the sensors may photograph a paved road, which may be readily recognized by image capture algorithms on the controller or back at the vehicle. At block 314, the drone may measure the depth of a river, pond, lake, or other body of water. For example, a stage radar or Lidar on the drone may capture the depth to determine whether the vehicle is able to successfully negotiate the river. The velocity and river discharge may be measured using radars. The drone may also detect the size of bodies of water such as lakes. These criteria may be relevant to driver/vehicle awareness and vehicle capability. Large bodies of water, for example, may cause the driver to lose awareness in the direction of the body of water. As for depth, even a sophisticated outdoor vehicle is capable of submerging itself by a certain limit.

At block 316, the drone may use night vision and infrared sensors during its scout mission to support the overall assessment of conditions when the situation calls for it. The environmental condition may be cloudy or dark, as one example. The driver may also instruct the drone to engage these sensors via the user interface and data link. The infrared sensor may in many instances provide the drone with input data about an obstacle or source of heat (e.g., underground lava nearing the surface, etc.) that may not be conspicuous when using visible light. The data from these sensors may also bolster or enhance evidence of a particular topographic feature that may otherwise be ambiguous or mistaken for something else.

The number and type of sensor, and its capabilities (e.g., Multi-spectral Imaging, Detection and Active Reflection or MIDAR) are increasing continuously. The above examples are not intended to be exhaustive, and other sensor types may be used to receive different types of input data than the aforementioned, without departing from the scope of the disclosure. In addition to multi-spectral mapping, various sensors may perform atmospheric correction and mineral detection, among other possibilities.

Referring still to FIG. 3, information including the above-referenced features in example blocks 306, 308, 310, 312, 314, and 316 may thereupon be passed to block 318. In some configurations, this means transmitting the information to the vehicle over the data link, in advance or near real time, or otherwise. The processor may execute one or more AI-based algorithms to process the data in order to determine, based on select data from the vehicle and drone sensors, optimal routes and corresponding data to the driver/drone pilot via the output display. The results may be stored in a data repository or memory coupled to the processor and integrated with other data that may have been obtained from an earlier trip, e.g., a trip that overlapped with the target region.

In response, the driver may identify a single route as in block 320, or multiple routes as in block 322, of the plurality of vehicle routes made available. As noted, per the occupant's preferences, the route may relate to a manual hike, in which case different criteria may be processed to enable the occupant to hike. While obstacles may be easier to overcome in some instances via hiking, in other cases (e.g., high inclines and overall distances), driving may be desired. The processor may be programmed to execute instructions on the sensor data, whether directly or as processed through the drone's controller, based on the desired use of the route information. If more than one route is selected, in some arrangements the reported data for both routes may be integrated with the existing AI repository, such that the different routes may be revisited in the future.

At decision block 324, the vehicle occupant(s) may determine to explore one or more of the identified routes by indicating through the user interface their preference to explore by driving or hiking. In some configurations, this decision may have been input prior to the aerial scout mission by the drone, particularly in cases where the processing power of the drone's controller is used to make determinations that hinge on whether the route will be a vehicular route or a hike. If the occupants choose hiking, then at block 326, the driver/occupants/users may go out for a hike while the drone may remain available for further instruction. In further configurations, the hikers may have an application on a smartphone, or a handheld device using a proprietary network, to maintain contact with, and issue instructions to, the drone. The instructions in this configuration may be sent directly to the drone (e.g., as it recharges on a docking station), or via the vehicle to the drone.

Conversely, if the driver/occupant(s) elect to drive the route, the driver and vehicle occupant at block 328 may review the data and acknowledge the information provided by the system in advance in preparation for off-roading via the selected route. In some cases, the driver or users may at that point reconcile the end point of a route, which may or may not coincide with a destination used by the drone-based vehicle routing system to compute optimal routes with their respective degrees of difficulty. Here again, the energy management software may be an invaluable tool to facilitate the determination of the desired end point. In consideration of the potential effect on the range (e.g., the expected remaining charge in the case of an EV) as assessed by the system, the driver may elect to shorten the destination as noted.

In some aspects as noted, at block 326, the driver or users may elect to instead go out for a hike while the drone remains available (docked to charge or following the hikers). In this case, the cycle can return as the drone prepares to identify other alternatives for routes and, in the case of the hikers (block 326), the walking pathway ahead.

In other cases, such as block 328, the driver may elect to acknowledge the information provided by the vehicle in advance and prepare to face the off-road route identified by the system. Referring next to block 330, other aspects of the disclosure allow for dynamic use of the system—including the processor and the drone- to provide guidance in or near real time, or otherwise provide guidance dynamically, to overcome the identified obstacles more efficiently. For example, the driver or vehicle may issue another instruction to the drone for further analyses of particular obstacles along the way that pose a greater problem than expected. In like manner, the vehicle sensors may be used constantly, or reengaged as needed to make additional or supplemental determines from a ground view. The processor may perform additional algorithms on the newly collected data from the drone and vehicle. One set of such algorithms includes consideration of driver experience, driver skill level, driver profile and vehicle capabilities as applied to the newly integrated data. Corrections or adjustments may be made to the data or the recommendations in or near real time.

Once the destination is reached control of the process may return to decision block 304. Provided ample range remains, the driver may request the system to reengage the drone to assess a new target region. In other cases, the drone may be redeployed in a region that is in the direction of the ultimate destination—such as home—of the driver.

FIG. 4 is a flow diagram 400 illustrating an example energy management system of the drone-based routing determinations. As in previously discussed aspects, a drone may be instructed by the vehicle processor to aerially scout the terrain to provide sensor data to the vehicle and/or to perform independent computations based on the data to assess the alternative routes that appear to be available. The drone's controller may communicate an estimated energy consumption to the vehicle over the data link for each route that compares the relevant road/path conditions and its obstacles with the available remaining range of the vehicle. In accordance with this general set of principles, at block 402, the system may enter into AI scout drone mode, such that the drone is deployed to gather data. Advantageously, the mutual data link allows the controller equipped on the drone to gather, where appropriate, data that is also being gathered by the vehicle, as well as data from the repository. Thus, while many aspects of the disclosure are vehicle-centric in the sense that the drone's primary role is a scout and a client for gathering data for use by the sophisticated processor of the vehicle, other aspects contemplate that a non-insubstantial portion of this computational power be relegated to the drone. In this example, the drone may play an important role in energy management determinations, which in turn may be provided to the vehicle.

At block 404, the drone may proceed to explore the nearby area in order to map possible alternative routes having different respective levels of difficulty, where available, for use in the off-roading experience of the driver and occupant(s). As a nonlimiting example, a drone in one scenario may fly up to eight miles ahead of the vehicle to assess the route that is being considered in advance, while the vehicle remains parked. The driver and crew in this illustration may stay at their current location to contemplate a scenic view, enjoy a meal, or simply stretch and take a stroll, while the drone is deployed to assess the landscape and have the assessment for the contemplated route ready to be used when the vehicle initiates the trip.

In some aspects that may be particularly advantageous in the exemplary factual scenarios outlined above, the drone may be further equipped with an output display wired into the system via the data link and used by the driver and crew while outside the parked vehicle to study the alternatives identified by the drone. In other cases, the drone transmits its determinations, which indirectly or directly include relevant sensor data acquired by the drone, to the vehicle. The processor may then execute algorithms, where suitable, to take into account driver-specific and vehicle-specific data. In this case, since the current range of the vehicle (for example) originates from a sensor aboard the vehicle, the vehicle sensors are still relevant to the determinations of the route regardless of the selected portioning of processing power between the controller and the processor. Further, where a plurality of routes are selected for exploration, the vehicles' processor may execute functions to predetermine a target region associated with these routes along with whatever vehicle data is needed. This information may in turn be passed between the vehicle and the drone, in whatever direction is suitable at the time and under a given set of circumstances.

At block 406, the scout AI drone may provide an estimate of energy likely to be consumed in each one of the routes assessed in advance. The prediction may be based on landscape information, for example, over the next five miles, further taking into account the origin to which the vehicle will return after the off-roading activities. The origin may simply be the driver's locale as specified above, or the nearest charging station, in the case of an EV. In addition, the luxury of the range estimation suite of algorithms may provide an otherwise anxious driver with greater confidence and peace of mind, because the driver may be reasonably certain that the vehicle will not exhaust its energy and come to a sudden halt in the middle of a trail.

The landscape information referenced in block 406 may include topographic features, the elevation gain along the route, etc. that reasonably bear on the anticipated energy consumption of the vehicle that may be needed for the vehicle to handle the offroad obstacles to reach the aimed destination. Landscape information may include, without limitation, the terrain incline, the elevation from current location to destination, the nature of the terrain (which encompasses criteria like whether the terrain is muddy, flooded, includes gravel, etc.), and like factors that would increase the energy required for the vehicle to travel a prescribed distance. These factors may also take into consideration, for example, the driver's profile based on self-learning algorithms, determinations of driver experience and skill based on prior routes/types of obstacles and prior failures and successes in negotiating similar obstacles relative to how fast and effective the driver can overcome the offroad overall conditions as assessed in advance. Some example algorithms compare these features with the estimated energy or range required for the vehicle to hypothetically travel the same distance on a level, paved road to enable the controller to compute a final estimate. This energy management resource is particularly advantageous for new and previously unknown routes, or for routes which have experienced significant natural or artificial changes.

At block 408, the driver may select the desired route via the user interface, taking estimated energy range into account. Thereupon, at block 410, the driver may enjoy the offroad trip for as long as the energy management determination recommends.

FIG. 5 is a flow diagram 500 illustrating a plurality of alternative activities achievable by a driver and a vehicle occupant using the drone-based system. The system in FIG. 5 may also be performed by different components of the drone-based system. These include the processor, the controller, the various sensors, the user interface, and other components of the vehicle and the drone. The example diagram 500 may be relevant to a situation where the vehicle (or the occupants) instruct the drone to explore a perceived scenic area identified previously to the occupants in a video or photograph. The area may include a waterfall or other area of natural scenic beauty. Upon performing a flight to scout the target region, however, the drone concludes that there is no paved or otherwise commonly used road to the destination associated with the attraction of interest.

With that example background, at block 502, the driver, occupant, or AI features draw attention, based on a previously viewed video of an attraction, or an output display from the processor executing AI code and configured to identify relevant such attractions, draws attention to the presence of the nearby attraction. In this example, the attraction is a waterfall. At block 504, the driver or occupants show interest in exploring the waterfall. Upon selection of an input such as using a touchpad showing the attraction's picture, the routing system may be engaged, initially as a navigation system in some cases. Where the navigation system (GPS) does not find in its set of maps in memory a legal or paved road from the present location of the vehicle to the attraction, the vehicle may instruct the drone (with the input of the occupants or autonomously) to scout the target region from the present location of the vehicle to the general area of the attraction. Having scanned the area, the drone at block 506 may report that there is no available paved or otherwise established road to the attraction.

As a result, at block 508, the driver/occupant sends the drone to proceed to perform a detailed assessment establishing whether a possible route exists that the vehicle may reasonably use to drive offroad to the desired destination. The drone may still be aerial, and thus may receive the instruction from the vehicle over the data link. At block 510, the drone navigates the region, potentially adjusting altitude and performing other maneuvers to use its sensors optimally to assess topology/topography, and to penetrate and categorize the vegetation canopy overlying the area in order to obtain a close visual inspection of the ground across the target region and measure in detail the bare earth features.

At decision block 512, the controller may then determine, based on the detailed input data gathered by the drone sensors, whether the vehicle is capable of overcoming the identified landscape in the region to navigate to the desired destination. At this point, in some configurations, the vehicle may provide the controller over the data link with vehicle measurements and other vehicle data, along with driver skill levels if available, to enable the controller to take these criteria into account. This information may already be stored in the drone's memory, for example, and updated periodically by the vehicle as the drone-based routing system is used over a period of time. If at block 512 the drone determines that it has found one or more feasible routes that comport with the guidelines of the vehicle and that are commensurate with the driver's skill level, then at block 514, the drone proceeds to identify the optimized route and provide guidance to the driver. In other aspects, the drone may pass the information to the vehicle via the data link, where the processor makes this determination instead, incorporating other algorithms discussed above.

Thus, at block 530, the driver may identify a route (if more than one is displayed on the output display) and may proceed to conduct the vehicle along the identified route toward the waterfall. In various aspects that provides an extra level of security, the drone may continue to monitor the chosen route closely in real time while the vehicle is proceeding to the destination, in which event the drone and vehicle may exchange data over the link dynamically or in or near real time, as the network capabilities may allow or per the set preferences. The drone, in relaying continued information to the vehicle, may enable the processor to recommend adjustments to the route where needed, at block 534. In some configurations, the adjustments are directly sent to the vehicle and displayed to the driver, who in turn monitors the vehicle to align with whatever suggested changes are relayed. This drone monitoring may continue until the drone is instructed to land, the drone's own energy reserves create the need for landing, or the driver successfully reaches the waterfall. Control returns to block 502, and the driver may elect to use the drone again to assist in returning to its earlier location or, range permitting, identifying a new attraction.

By contrast, if the drone (or vehicle via the drone) determines that there exists no path to the destination using the vehicle, at block 526 the drone communicates to the vehicle that the scenic area is not accessible by the vehicle. At block 528, the drone may instead offer the driver or occupant alternatives. For example, one such alternative at block 522 may be relayed to the driver to return to off-roading and explore one or more adjacent areas in order to map possible alternative routes to augment the vehicle's AI repository and increase the scope of the offroad alternatives. Control returns to block 502.

In another configuration, at block 520, the drone may convey to the vehicle for display to the driver or occupants that the original attraction may in fact be reached by walking or hiking, and that during the walk or hike, the drone may provide additional guidance to ensure that the hikers remain on the correct route or easiest path, if applicable. The user at block 524 is, of course, free to decline the hike and return to off-roading. Otherwise, at block 518, the user (that is, the driver or one or more occupants) may decide to hike to the waterfall. If the user remains stationary, then at block 516, the drone reconsiders the data based on the behavior of the user and provides the most ideal route for reaching the destination on foot. In other configurations, the user conveys its desire to hike by engaging a switch or touchpad on the user interface.

While the example of FIG. 5 has the drone performing most of the larger scale computations and potentially involves a larger and longer flight (or series thereof), in other configurations the vehicle may take more of the processing load and make the same determinations based on raw sensor data from the drone. This configuration may be more suitable when the drone has less range or has less sophisticated processing circuitry than the vehicle. Advantageously, this determination may also be made in real time, depending on the remaining energy of both the vehicle and the drone, the latter of which may have its own energy management capability to ensure that it has sufficient power or that it may be recharged/refueled when it begins to run low.

FIG. 6A is a block diagram of an example processing system 600a in a vehicle 123. The processing system includes processor 604, which represents the processor described in previous aspects. Processor 604 may be used to make measurements and detections, and to control various switches as described more fully herein. The processor 604 may in some arrangements include more than one processor. Processor 604 may include one or more central processing units. The functions performed by processor 604 may be performed in software, hardware, firmware, middleware, or a combination thereof. The processor 604 may execute algorithms on one or more layers. Thus, the processor 604 itself may vary widely in its architecture. In vehicle implementations, the processor 604 may be deemed for purposes of this disclosure to include the hardware (including without limitation one or more Electronic Control Units (ECUs)) used to execute the vehicle functions described herein. For example, the processor 604 may include one or more general purpose processors, special purpose processors, complex instruction set computer (CISC) processors, reduced instruction set computer (RISC) processors, and/or other types of processors. Processor 604 may include multiple processors, whether homogenous or heterogenous, dispersed throughout the vehicle and used for receiving vehicle sensor data and performing the computations needed to implement the vehicular side of the drone-based routing system. Each of the processors included as part of processor 604 may include different numbers of cores (one and greater) and may include cache memory, busses, registers, and other similar processor components. In other cases, some or each of the functions of processor 604 may be performed in hardware. Thus, in some exemplary aspects, processor 604 may include one or more digital signal processors (DSPs). systems-on-a-chip (SoCs), field programmable gate arrays (FPGAs), application-specific integrated circuits (ASICs), dedicated logic circuits, combinational or other hardware circuits for implementing functions in hardware, CPU(s) for executing code, or some combination thereof. As noted above, if some or each of the functions of processor 604 are performed in software, the software may include or involve middleware, firmware, application programming interfaces or other types of code. In some embodiments, processor 604 is part of a separate computing device embedded within vehicle 123, whether on its own or used in tandem with one or more other embedded computing devices. The processor 604 may also include one or more computing devices, in some cases in an internal vehicle network) for performing the above-described algorithms, in hardware or software.

Referring still to FIG. 6A, processor 604 may include an input coupled to a crystal oscillator or similar stable clock signal. In some embodiments, the clock information may be internal to the processor 604. The processor 604 may be programmed to perform a function periodically on a specific time and date, or after passage of a specified time period. The processor in these embodiments has accurate timing information in its possession and may perform the specified function accordingly.

The processor 604 may be coupled via bus 624 to a memory 608. Memory 608 may be multiple vehicle memory devices for storing, pre-storing, and dynamically adding or modifying data for use with the different applications identified in this disclosure. The processor 604 may include cache memory stored within the processor itself, although in other embodiments, additional cache memory may be physically separate from the processor. The memory 608 may include different forms of computer-readable media including, but not limited to and by way of example, solid state memory, flash memory, magnetic or other hard disk drives, and physical memory implementations in whatever form. Memory 608 may include different memory architectures including but not limited to read-only memory (ROM), random access memory (RAM), static RAM dynamic RAM, cache memory, and the like. Information calculated by processor 604 may be stored, temporarily or permanently for future use. Memory 608 may include the data repository and databases described herein, for storing AI and self-learned acquired data, for providing data to the processor 604 over bus 624 to enable calculations, and for storing data in the remaining contexts that may be needed to implement the vehicle architecture. Memory 608 may also be used to store input data received from the drone, via the data link. The processor 604 (or the controller 603 of the drone) may continually update the database repository(ies) in memory 608 with new and/or substituted information.

The processing system 600a further includes vehicle sensors 610, described in greater detail herein. These vehicle sensors may include vehicle range, information about the height of the vehicle base above the ground, in light of the tire pressure, and a host of other navigational sensors, including rear-view cameras, side-obstacle warning systems, side and front view cameras in some cases, and the like. More sophisticated off-roading vehicles may include ground-based radar, lidar, sonar systems, and other sensing equipment. Sensors may also include accelerometers, odometers, speedometers, gyroscopes, and other sensors that may be relevant to driver experience and the ability of the vehicle to continue free of material mechanical problems. The processor 604 may make determinations based on vehicle data as to whether the vehicle is capable of continuing on the offroad excursion, or whether, for example, a problem is detected that may affect the success of the trip.

Bus 624 may include a single physical link, or a plurality of physical links between the various devices within vehicle 123.

The processing system 600a further includes an output display 606 (e.g., an infotainment display). This output display 606 may include, for example, the output displays 108, 110, 112 and 114. Commonly, the output displays may include an input touchpad so that the user may make selections by touching illustrations also used as input. Thus, the processing system 600a includes a user interface 614, such as drone controls 104 and 116. User interface 614 may also include output displays 606 that enable the user to depress areas with certain text or illustrations (e.g., in rectangular boxes), as is commonly used in tablet personal computers (PCs) or smart phones. The user interface 614 in one configuration may include the input controls/buttons within the vehicle that enables the driver/user to make full use of the drone-based system. Similarly, the output display 606, which may include one or more display screens, may include the output for displaying data sufficient for the driver/user to make use of the drone-based system.

The processing system 600a further includes the vehicle sensors 610, which may include the sensors in the vehicle including cameras, motion detectors, radars, lidar, and other available sensor types, present now or forthcoming, that enable a robust ground-based data retrieval system. Using the vehicle sensors 610, the processor 604 may receive input data required or helpful for the drone-based vehicle routing system to display the most optimal routes with precise and feature-rich information. The vehicle sensors 610 may include, in addition to the above, the sensors needed for the vehicle to properly and optimally function. These include tire pressure sensors, one or more temperature sensor, mileage/range sensors, engine performance sensors, oil pressure sensors and other vehicle sensors relevant to confirming that the vehicle is in fact in a position to proceed with offroad activities.

The vehicle's processing system 600a also includes a transceiver 620, which may include one or more circuit devices for use by the processor 604 in sending data to the drone and receiving data from the drone. The transceiver 620 may be used by the processor 604 to establish a data or communication link 648 between the vehicle and the drone. The processor 604 may use transceiver 620 to transmit, via one or more antennas 622 the data from the repositories and databases in memory 608 (which again may include multiple memories) to the drone, as appropriate under the circumstances. The processor may communicate this and other information over bus 624. In some configurations, the transceiver 620 may include multiple components, such as a separate transmitter and associated circuitry, and a separate receiver and associated circuitry. Transceiver 620 may also be partitioned into a plurality of circuit components that are configured to execute multiple network protocols, and multiple layers of the protocols. Processor 604 may receive information from the transceiver 620 over bus 624 and execute operations on data over different abstraction layers. The antenna 622 may be a single antenna, a plurality of antennas, or an antenna array (e.g., the latter for performing antenna steering and other more sophisticated transmission techniques). For clarification and simplicity, the data link 648 is deemed for purposes of this disclosure to generally reference the signals transmitted from each of the antennas, if more than one exist.

The processing system 600a may also include docking hardware 627. This docking hardware may include a docking station that may be coupled in a wired or wireless fashion to data link 648. This docking hardware 627 may also include a charger, in the case of an electric-powered drone, to charge the drone using energy from the vehicle or the vehicle's battery cells or generator, or a dedicated battery (or set of battery cells) or generator within the vehicle 123. In practice, the docking hardware 627 may include a docking station on the roof or in the rear of the vehicle, such that the drone 102 is secured snugly when the vehicle is in motion, and may be unlatched (in some cases, automatically) when instructed to fly. In some configurations, the docking hardware 627 includes a horizontal platform in the back of the vehicle 123 below the vehicle roof such that the drone places negligible drag on the vehicle 123 when the latter is in motion, and such that the interior of the vehicle remains available for luggage and other items. In practice, a large number of types of docking hardware 627 may be implemented for hitching the drone 102 to the vehicle 123.

FIG. 6B is a block diagram of an example processing system 600b in an aerial drone 102. The drone 102 includes a controller 603, so named to distinguish it from the processor 604 equipped with the vehicle. That said, controller 603 may, similar to processor 604, include a plurality of processors, the totality of which is referred to as a controller to execute the aerial scout functions including to maneuver the plane (on its own or with the guidance of the drone-based system or a user with a handheld device hiking through the woods, for instance), and to receive input data from the one or more drone sensors 629. The controller 603 may in some aspects perform sophisticated assessments of the received data from one or more drone sensors 629 and may make determinations based on the drone sensors.

The controller 603 is further equipped with a transceiver 605. Transceiver 605 may, like the vehicle transceiver 620, be partitioned into a separate transmitter and receiver, or it may be a single unit to preserve real estate on the drone 102. Controller 603 may use transceiver 605 to send and receive data and instructions over the data link using antenna 640. Antenna 640 may be a plurality of antennas an array of antennas like in the vehicle 123. Transceiver 605 is configured to work seamlessly with one or more prescribed wireless network technologies as described above with respect to the vehicle 123. Transceiver 605/620 may also be configured to transfer wire over a hardwired data link when the drone 102 is docked using docking hardware 627 (FIG. 6A).

Referring still to FIG. 6B, the drone 102 may further include a memory 607, which may have the same features as the memory 608 described above with reference to the vehicle 123. The memory 607 in the drone may be more compact. The memory 607 may include an operating system that supports flight control and that includes an application programming interface (API) that may be used by the vehicle-based applications. In some cases, the processing system 600b may also include swappable or permanent flash memory 609. Where the drone 102 is powered by electricity, the processing system 600b may include a battery 613. The battery 613 may be a battery cell or plurality of rechargeable cells. The drone 102 may be charged when docked with the vehicle's docking hardware 627.

The processing system 600b also may include an aerial control system 615. In some arrangements, aerial control system 615 is part of controller 603, whether or not it is integrated therewith. In other cases, aerial control system 615 is a separate processor using software or dedicated hardware to control the drone including ascending, descending, turning, taking off, landing, and performing whatever aerial maneuvers, whether independently, under control of controller 603, or under control (or partial control) of the vehicle via communication link 648. Like the remainder of the components of processing system 600b, the controller 603 and aerial control system 615 may be coupled to the transceiver 605 and hence the data link 648 via bus 624. The bus is shown in this example as including a single connection to each element. However, in other cases the bus may be partitioned into a plurality of wires, traces, or other conductors for exchanging data between the components of the drone 102.

In some aspects, the drone 102 may include a display 611. The display may be rudimentary as in one or more LED lights. In other examples, the display 611 may be a more sophisticated LCD, LED or other display for listing route information. This feature may be useful for hikers that are followed by the drone, such that the drone may land and be accessible to the hikers, the latter of whom may examine the display 611 for updated route information. In other arrangements, the display 611 is not present, and the data may instead be routed to the smart phone or other handheld device of the hikers.

The drone sensors 629, described at length above, may vary in size, number, type, and sophistication level depending on the relative sophistication of the system and of the drone. It will be appreciated that sensors not described in this disclosure may also be included in the drone without departing from the disclosure, as the form factor, features, sophistication and functions become increasingly advanced. The drone sensors 629 not just include those sensors used to map the topographic features of a region, but also may include sensors that assist the aerial control system 615 and/or controller 603 in navigating the drone (gyroscopes, accelerometers, altimeters, and the like).

The processing system 600b may further include a dock interface 617 which may include a set of pins, plugs, or adapters included for connecting with the docking hardware 627. This connection interface enables the vehicle 123 to charge the drone 102. Further, this connection may also be a data connection which allows the respective processor 604 and controller 603 to exchange information at potentially very fast rates between the drone and vehicle.

The vehicle may also be equipped with mass storage 612 used for storing the database repository of information gathered from the drone and vehicle sensors; the relevant applications, and other data used for implementing the system. Mass storage may include disk drives, hard disks, flash memory, or non-volatile memory of any kind. Portable storage 616 may include any type of memory that can be removed from the vehicle, e.g., and replaced. Portable storage 616 in some embodiments may be usable in the drone. The vehicle may further include one or more peripheral devices 618 including other types of displays and user interfaces, as well as computer based peripheral devices or interfaces for such devices (mice, wireless keyboards, wireless tablets, and the like).

In summary, and as but a few nonlimiting examples, the following disclosure presents a drone-based vehicle routing system which includes, among others, the following advanced features:

In one aspect, the system (vehicle or drone) executes an algorithm that classifies the driver's history and profile based on skills such as beginner or high experienced. and take it in consideration when providing guidance or recommendations. In another aspect, the system identifies unique routes not previously mapped (e.g., not used as a trail before), based on a potential destination captured by the drone imagery, such as in the waterfall example described above. In a third aspect, the system calculates a route skill level severity (e.g., Expert/Intermediate/Beginner) based on types of obstacles, relative clearances, and other factors.

In another aspect, the system maintains an energy management feature for EVs. Energy management assists with enabling the driver/occupant/users to make better decisions relative to estimated range left after facing such obstacles and distances. In another aspect, the system may proactively find paths and routes by mapping vehicle capability vs. terrain limitations, measure distance of route, width between obstacles, inclines, turn radii, depths of water, obstacle heights to clear (rocks, stumps, etc.) and map to undercarriage clearance, tire size, vehicle width, turning radius, crab mode, etc., where the system presents this information via an output display (e.g., an infotainment system) allowing the driver and occupants to take the best decision in advance.

In another aspect, the system provides a warning if the route contains dangerous conditions or is too difficult for either the vehicle or the occupant. In another aspect, the system uses existing diagnostic trouble codes (DTCs) and prognostic information as algorithmic inputs to determine if the route may cause another failure or may result in further damage to the vehicle (e.g., powertrain overtemperature, tire pressure too low/high). In another aspect, the system may detect and characterize existing or previously used vehicle paths and their respective conditions that may be hidden by vegetation, snow, leaves and are not visible by naked eye to be used as an alternative route. In another aspect, the system may create models that bound the possibilities in the lateral directions based on driver time input, vehicle range possibilities, and other factors.

In another aspect, the system may assign a driver a skill level based on previous routes successfully completed (e.g., widths, depths, heights, inclines, etc. traversed) and driver behavior scores (past stuck wheels, spinning tires, minor collisions, distances cleared, obstacles climbed, inclines achieved, etc.) where the algorithm classifies the driver's history and profile based on skills such as beginner or high experienced and takes the skill level into consideration when providing guidance or recommendations. In another aspect the system may recommend routes and indicate difficulties based on both driver skill and complexity of the route (using color such as red/yellow/green). In another aspect, the system may recommend one or more hiking routes as a possibility for a leg of the journey, where a vehicle is incapable of successfully traversing obstacles to reach a destination. In another aspect, the system is configured to use difficulty ratings (distance, incline, dangerous obstacles, etc.), to estimate time to travel a prescribed distance. These are but some of the aspects of the disclosure as discussed in more detail with reference to the drawings.

Numerous benefits and advantages may be drawn from the disclosure. The system improves navigation experience by providing new routes that would not previously have been known or attempted. The system accomplishes this benefit by assessing the offroad conditions while flying ahead of the vehicle; identifying and communicating the data back to the vehicle's output display (such as, for example, an infotainment screen) the following data with the aim to provide ultimate guidance for the driver/occupant. The system may identify and recognize inclination, approach and departure angles, slope angle, identification of obstacles, temperature, types of pavements, river/lakes and other bodies of water. These conditions give drivers some guidance based on difficulty and skill level and reduce driver anxiety concerning whether the vehicle may successfully negotiate the route without becoming stuck or damaged, or both.

Another understanded advantage is that the vehicle brings unique data to applications and algorithms as described above. Thus, the vehicle may provide unique insights that drones do not possess on their own. Similarly, the vehicle advantageously provides drivers and occupants useful information to strategically plan the route in advance. The driver may uniquely comprehend the route's characteristics in terms of overall path condition and its obstacles to be tackled. The system may beneficially also merge drone data with vehicle data and capabilities to determine route achievability. This advantage becomes manifest when the system compares and reconciles drone mapping telemetry and vehicle characteristics and geometry, thereby assuring the driver that the mechanics and geometric measurements of the vehicle and its ride mode selection are adequate to traverse the route at issue.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. Moreover, this disclosure expressly includes combinations and sub-combinations of the elements and features presented above and below.

What is claimed is:

1. A system for drone-based offroad vehicle routing, comprising:
a vehicle comprising a processor coupled to first sensors, the processor being configured to receive data from the first sensors; and
an aerial drone comprising second sensors, the drone and the vehicle being configured to establish a wireless communication link for exchanging data therebetween, wherein:
the processor is configured to instruct the drone to aerially scout a target region and engage the second sensors for detecting topographic features relevant to possible offroad vehicle routes;
the drone is configured to scout the target region and receive data comprising the topographic features including overall obstacles from the second sensors for transmission back to the vehicle in advance or near real-time; and
the processor is configured to determine, for display to a driver, at least one vehicle route from a current location to a destination based on analyses of data from the first and second sensors.

2. The system of claim 1, wherein the topographic features include newly identified prospective paths or preexisting paths.

3. The system of claim 1, wherein the data from the first sensors comprises: ground clearance; path or road width; turning radii; climb capability; or vehicle range.

4. The system of claim 1, wherein the data from the second sensors comprises: terrain; vegetation canopies; inclination; approach or departure angles; slope angle; natural or artificial obstacles; temperature; pavement types; rivers, lakes or bodies of water or conditions thereof, presence or location of social media members; distances; path widths; or road widths.

5. The system of claim 1, wherein the processor is further configured to estimate, based on data from the first or second sensors, a relative level of difficulty for ones of the possible offroad vehicle routes.

6. The system of claim 1, wherein the drone comprises a controller configured to estimate, based on data received from the second sensors, an amount of energy consumption required for the vehicle to travel different routes.

7. The system of claim 6, wherein the controller is configured to estimate a remaining vehicle range and to transmit, to the vehicle, information comprising the remaining vehicle range or a warning based on the remaining vehicle range.

8. The system of claim 1, wherein the second sensors comprises a lidar, a radar, a sonar, a thermo-sensor, or a night vision detector.

9. The system of claim 1, wherein the processor is further configured to store information relevant to the possible offroad vehicle routes in a memory for use in future trips.

10. The system of claim 9, wherein the information relevant to different ones of the possible offroad vehicle routes includes relative levels of difficulty.

11. The system of claim 1, wherein the processor is further configured to determine the at least one vehicle route based on a combination of vehicle capabilities with capabilities or a skill level of the driver.

12. The system of claim 1, wherein the processor is further configured to determine the at least one vehicle route based on criteria or preferences of the driver that are input into the vehicle via a user interface.

13. The system of claim 1, wherein the processor is configured with self-learning capabilities to make predictions relevant to the at least one vehicle route by selectively assessing a relevance of different elements of the data from the first and second sensors.

14. A system for off-road drone-based routing, comprising:
a vehicle comprising an output display, and a processor coupled to first sensors and configured to receive input data via the first sensors; and
an aerial drone comprising second sensors, the drone and the vehicle being configured to establish a data link for exchanging data therebetween, wherein:
the drone is configured to scout an identified region based on instructions from the vehicle, to engage the second sensors for detecting features relevant to possible vehicle routes to a destination in the region, and transmit input data from the second sensors back to the vehicle; and
the processor is configured to selectively assess relevance of the input data from the first and second sensors, to determine, optimal routes to the destination based on the selective assessment, and to display the optimal routes to a driver via the output display.

15. The system of claim 14, wherein the processor is further configured to determine the optimal routes based on a driving history or skill level of the driver.

16. The system of claim 15, wherein the processor is further configured to determine the skill level of the driver based on data including previous routes successfully completed or driver behavioral scores in negotiating prior obstacles while driving.

17. The system of claim 14, wherein the processor is further configured to calculate a relative level of difficulty for each of the one or more optimal routes.

18. The system of claim 14, wherein the processor is configured to issue a warning to the driver for routes that include a dangerous condition or that are determined too difficult for the vehicle or the driver.

19. The system of claim 14, wherein the optimal routes include recommended routes based on (i) driver history or skill level, (ii) preferences input into a memory of the vehicle, and (iii) a relative topographic complexity of routes.

20. A method of operating a vehicle communicatively coupled to an aerial drone, comprising:
receiving input data via first sensors positioned on the vehicle;
issuing instructions to the drone to aerially scout a target region and engage second sensors equipped therein to detect, when in flight, topographic features relevant to possible vehicle routes;
receiving, from the drone responsive to the instructions, information including input data captured by the second sensors while the drone is in the flight;
using the input data from both the first and second sensors to determine optimal vehicle routes from a present location of the vehicle to a destination in the target region; and
displaying information comprising the optimal vehicle routes on an output display.
